(19) United States
(12) Patent Application Publication
(10) Pub. No.: US 2009/0211497 A1
(43) Pub. Date: Aug. 27, 2009

(54) TRANSPORT PALLET MADE OF PLASTIC

(76) Inventor: Achim Koenes, Wülfrath (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 10/597,210

(22) PCT Filed: Jul. 21, 2004
(86) PCT No.: PCT/EP04/51571

§ 371 Date: Jul. 17, 2006

(30) Foreign Application Priority Data
Jan. 18, 2004 (DE) 20-2004-000-721.5
Jun. 2, 2004 (DE) 20-2004-008-778.2

(51) Int. Cl. B65D 19/38; B65D 19/24; B29C 39/24; B29C 39/26

(52) U.S. Cl. 108/53.1; 264/299; 249/203

(57) ABSTRACT

The invention relates to a stackable transport pallet of plastic. The pallet comprises a top side that forms an essentially flat support surface (1) and several support feet (2) that are disposed on the bottom side of the transport pallet and are hollow and open towards the top side so that they can nest inside one another when stacked. In addition, the underside of the transport pallet is provided with reinforcement ribs (4, 8, 9, 12). The transport pallet is produced from a plastic mixture containing recycled plastic material with the addition of organic fibers, in particular recycled PE or PP plastics with the addition of organic cellulose fibers or hemp fibers. This permits a high load-carrying capacity and a long service life to be achieved with a cost-effective use of material.

The present invention relates to a stackable transport pallet made of plastic.

Transport pallets are typically produced in standard dimensions, for example in the so-called Euro-pallet size 1000 mm×1200 mm, or with the dimension 800 mm×1200 mm, and are frequently made of wood. However, such wooden pallets have a relatively high tare weight and a low load carrying capacity relative to their tare weight. Another problem is weather resistance when stored outside, because wood absorbs moisture which can cause mold and rot. In addition, the stacking height of wooden pallets is limited.

It is therefore an object of the invention to provide a stackable plastic pallet which can be manufactured inexpensively and has a large load carrying capacity and simultaneously a low tare weight.

The aforementioned object is solved according to the features of claim 1.

Advantageous embodiments of the invention are recited in the dependent claims.

In the context of the invention, recycled plastic with addition of organic fibers is employed, preferably with addition of organic cellulose fibers. This produces a type of micro-reinforcement of the plastic, by which the tensile strength and the flexural strength and hence also the stability of the material can be significantly improved. As an alternative to the cellulose fibers or in addition to the cellulose fibers, hemp fibers can also be used.

Recycled plastics are, for example, mixtures of polyethylene and/or polypropylene and/or polycarbonates with a foreign matter fraction of no more than 10% (by volume). Such plastic materials are widely available in Germany as a result of the so-called package recycling.

The employed cellulose fibers preferably have an average fiber length in the range of 0.5 to 3 mm, preferably 1 to 2 mm, in particular preferably of approximately 1.4 mm. The average diameter is in a range of 10 to 100 micrometers, preferably approximately 60 micrometers. This results in a tensile strength of the fibers of at least approximately 1 N/mm².

The volume fraction of fibers is between 3% and 50%, preferably between 10% and 20%, particularly preferred at approximately 15% (i.e., 15% fibers and 85% plastic material mixture). The precise employed fraction depends on the quality of the recycled plastic material mixture and the requirements for the supported loads. In general, the stability of the plastic material tends to increase with increasing fraction of cellulose fibers.

According to another embodiment of the invention, the object of the invention can also be solved by providing the pallet with a particular shape. The object of the invention can be solved with these shape aspects, independent of the specific material selected for the plastic from which the pallet is manufactured.

The invention will be described in more detail hereinafter with reference to the drawings. It is shown in:

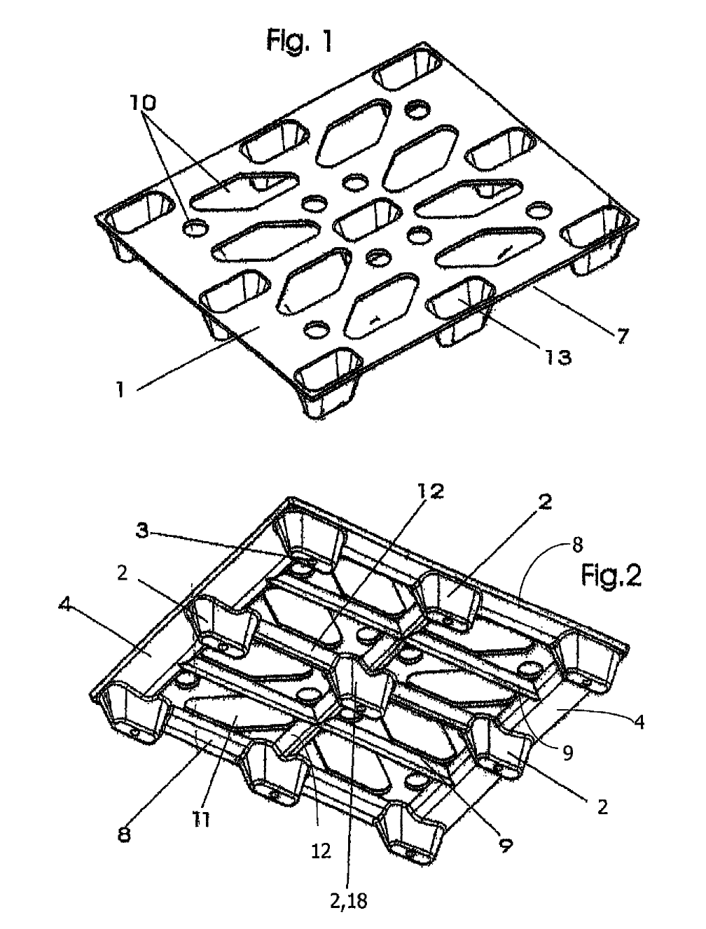

FIG. 1 a perspective view of the top side of a plastic pallet according to the invention;

FIG. 2 a perspective view of the bottom side of a plastic pallet according to the invention;

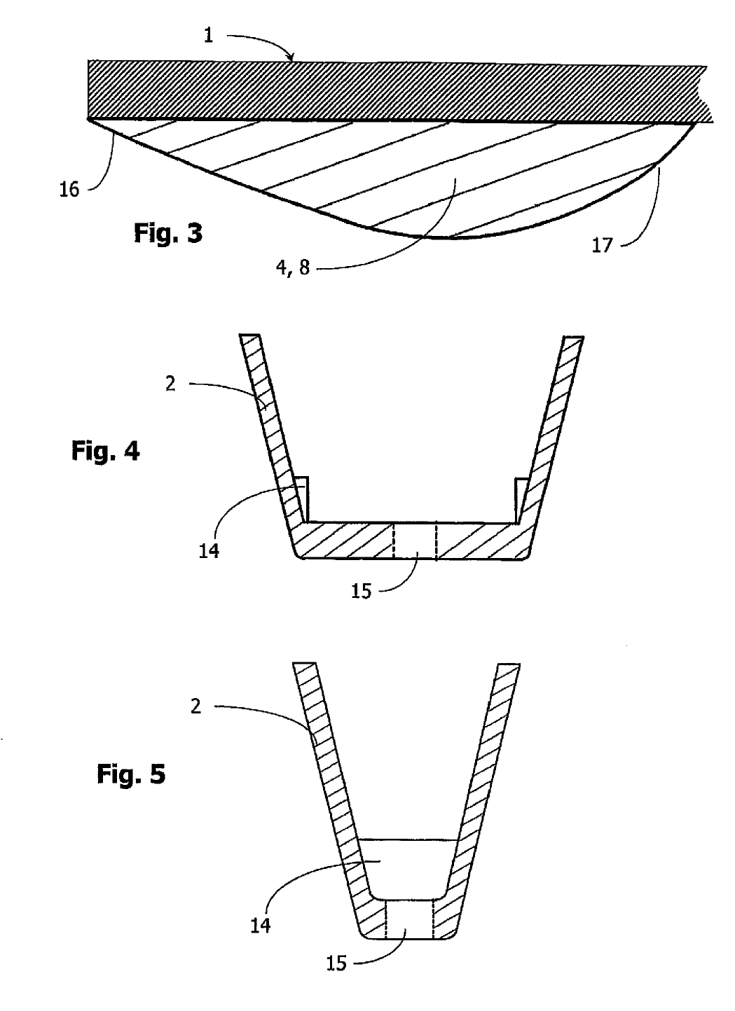

FIG. 3 a cross-sectional view (not to size) through the drop-shaped edge of a plastic pallet according to the invention; and

FIGS. 4 and 5 cross-sectional views of the support feet of a plastic pallet according to the invention.

FIGS. 1 and 2 show an exemplary embodiment of a plastic pallet according to the invention with a rectangular shape (preferred dimensions: width 1000 mm, length 1200 mm, or width 800 mm, length 1200 mm) with a length side and a broad side which is shorter than the length side. The top side of the pallet forms a flat support surface 1 for the paletted goods to be stacked or transported. The pallet is supported by a total of nine hollow support feet 2 which are formed integrally from the plastic material of a pallet and which each have an opening 13 toward the support surface 1.

The support feet are arranged in three rows in form of grid, with eight support feet being arranged along the edge of the pallet (four thereof at the corners) and one support foot 18 in the center. Because the support feet 2 are hollow and open toward the support surface 1, the pallets can be stacked on top of one another, whereby the entire stacked height is reduced because the support feet 2 can be inserted into the opening 13 of an adjacent pallet, which also increases the stability of the produced stack. A fork of a forklift can be inserted in or engage with the lateral gaps between the support feet 2, so that the plastic pallet can be transported with the load or separated from other pallets of a stack. The support feet 2 have a rectangular shape, whereby the longer side is oriented parallel the length side of the plastic pallet. As a result, the gaps for insertion of forks of fork lifts are shortened less on the shorter side than on the length side, thus leaving sufficient space on all sides for the engagement of fork lifts. The support feet 2 are furthermore formed with a conical downward taper, so that the pallets are self-centering during a stacking operation.

As shown in the cross-sectional views of FIGS. 4 and 5, each support foot 2 has proximate to the foot bottom a projection, which is located on the inside of the sidewalls of at least one wall and forms a limit stop 14 for the support foot of another pallet stacked on top. This prevents the stacked pallets from jamming and also forms an additional air gap between sequentially stacked pallets, in which the fork of a forklift can readily engage. An opening 15 is provided in the bottom of each support foot 2 for drainage of liquid.

To improve the stability of the plastic pallets, reinforcing ribs are provided which are integrally formed on the bottom side and made of the plastic material. The edges of the pallets are hereby reinforced by marginal reinforcing ribs 4, 8 located along the edges, thereby connecting and stabilizing the support feet 2 disposed at the edges. As shown in FIG. 3, which is not to scale, the marginal reinforcing ribs 4, 8 each have a drop-shape with an edge 16, which is oriented with increasing thickness toward the edge of the pallet, and an edge of 17 oriented toward the inside of the pallet, whereby the curvature of the edge 16 is smaller than that of the edge 17. This specific shape makes it easier to lift the pallets when a fork of a forklift is inserted underneath the pallets. For static reasons, the reinforcing ribs 4 of the widthwise side have a greater volume than the reinforcing ribs on the length side. Furthermore, the respective support feet located midway along the respective sides are connected with the support foot 18 in the center by intersecting ribs 12 arranged in the form of a cross. Two additional reinforcing ribs 9 are arranged between the support feet for reinforcement in the longitudinal direction.

The pallet surface also includes a symmetrical hole pattern 10. This saves material and allows liquids to drain from the pallet surface.

The transport pallet of the invention can be economically produced by extrusion of a corresponding material mixture at temperatures between 160 and 180° C. in a closed mold connectable to the extruder.

A pallet according to the invention can attain a static load carrying capacity of typically 4000 kg and dynamic load carrying capacities of approximately 1500 kg. The pallets can be easily and inexpensively produced and can be reused without any problems. The pallet has a small tare weight in relation to the load carrying capacity and can be utilized over a wide temperature range from −40 to 120° C. Moreover, the employed plastic surfaces, unlike wooden pallets, can also be hygienically and easily cleaned even in moist environments.

To prevent goods placed on the transport pallets according to the invention from shifting, at least the top surfaces of the transport pallets preferably have an increased surface roughness. Furthermore, an edge protruding by several millimeters can be formed at the edges of the transport pallet (not shown in the drawings), which then forms a limit stop for the paletted goods placed on top. The limit stop need not be continuous along the entire periphery of the pallet, but can be omitted, for example, in the region of the corners which are most likely to sustain damage.

For increasing the load carrying capacity, additional rail-shaped runners can optionally be attached to the bottom side of the pallet. These runners may be clipped into the drain openings 15 of the support feet with pegs, whereby the rails extend parallel to the corresponding longer side of the rectangular support feet and connect the rows of support feet with each other.

The pallet of the invention is preferably produced by extrusion of the aforedescribed material mixture. Extrusion is preferably performed at 160 to 180° C. in a closed aluminum mold connectable to the extruder. The material mix is hereby portioned into the extruder, liquefied into a paste by heating, and pressed into the aluminum mold with the feed screw of the extruder. The material can be suitably compressed in the mold by adjusting the processing temperature and the feed speed. The mold is then disengaged from the extruder and cooled with water for hardening.

1-22. (canceled)

23. A stackable transport pallet, comprising a pallet body including
a substantially flat top side to form a support surface,
a bottom side,
a plurality of support feet disposed on the bottom side of the pallet body, with the support feet being hollow and open towards the top side of the pallet body, and
reinforcing ribs disposed on the bottom side of the pallet body, wherein the pallet body is made of a mixture comprising a recycled plastic material with addition of organic fibers.

24. The transport pallet of claim 23, wherein the organic fibers comprise hemp fibers.

25. The transport pallet of claim 23, wherein the organic fibers comprise cellulose fibers.

26. The transport pallet of claim 23, wherein the recycled plastic material comprises at least one member selected from the group consisting of polyethylene, polypropylene and polycarbonate.

27. The transport pallet of claim 26, wherein the recycled plastic material contains foreign matter with a volume fraction not to exceed 10%.

28. The transport pallet of claim 25, wherein the cellulose fibers have an average fiber length in a range of 0.5 to 3 mm.

29. The transport pallet of claim 25, wherein the cellulose fibers have an average fiber length in a range of 1 to 2 mm.

30. The transport pallet of claim 25, wherein the cellulose fibers have an average fiber length of approximately 1.4 mm.

31. The transport pallet of claim 23, wherein the organic fibers are selected to have a fiber tensile strength of at least approximately 1 N/mm².

32. The transport pallet of claim 25, wherein the cellulose fibers have an average diameter of 10 to 100 micrometers.

33. The transport pallet of claim 25, wherein the cellulose fibers have an average diameter of approximately 60 micrometers.

34. The transport pallet of claim 23, wherein the organic fibers have a volume fraction between 3% and 50%.

35. The transport pallet of claim 23, wherein the organic fibers have a volume fraction between 10% and 20%.

36. The transport pallet of claim 23, wherein the organic fibers have a volume fraction of approximately 15%.

37. The transport pallet of claim 23, wherein the pallet body has a rectangular base with a length side and a broad side which is shorter than the length side, said pallet body including nine support feet arranged in three rows, with eight of the support feet bordering lateral edges of the pallet body and one support foot being arranged in a center of the pallet body.

38. The transport pallet of claim 37, wherein the support feet have an elongated cross-section and define longitudinal axes oriented longitudinally in parallel relationship to the length side of the base of the pallet body.

39. The transport pallet of claim 37, wherein the support feet have conically shaped sidewalls and a base forming an interior space, the support feet further including spacers disposed in the interior space in a region of the base of the support feet.

40. The transport pallet of claim 39, wherein the base of the support feet is provided with a drain opening.

41. The transport pallet of claim 23, wherein the pallet body includes a wedge-shaped or drop-shaped edge formed on a reinforcing rib and disposed on the bottom side and tapered toward an outside edge of the pallet, said wedge-shaped or drop-shaped edge adapted to engage with the hoisting fork of a fork lift for separating pallets stacked on top of each other.

42. The transport pallet of claim 37, wherein the support foot in the center of the pallet is connected via respective ones of the reinforcing ribs with the support feet positioned midway between corners of the pallet body, with the respective ones of the reinforcing ribs forming a cross.

43. The transport pallet of claim 42, wherein other ones of the reinforcing ribs extend approximately midway in gaps between the rows of the support feet in longitudinal direction of the pallet body to the right and the left, respectively, of a longitudinal center axis and intersect with a central one of the reinforcing ribs in a transverse direction.

44. The transport pallet of claim 37, wherein border-side reinforcing ribs have a cross-sectional area which is greater on the broad side of the base of the pallet body than border-side reinforcing ribs on the length side of the base of the pallet body.

45. The transport pallet of claim 42, wherein the respective ones of the reinforcing ribs have a substantially triangular cross-section.

46. The transport pallet of claim 23, wherein the pallet body has a symmetric hole pattern in regions of the support surface that do not include support feet or reinforcing ribs.

47. The transport pallet of claim 23, wherein the pallet body is manufactured as a casting.

48. The transport pallet of claim 23, wherein the pallet body is manufactured by an extrusion process.

49. A mold for producing a plastic transport pallet of claim 1.
